(19) United States
(12) Patent Application Publication
(10) Pub. No.: US 2005/0214729 A1
(43) Pub. Date: Sep. 29, 2005

(54) Data processing system for education financing

(75) Inventors: W. Allen Greenly, Dallas, TX (US); James A. Dukowitz, Dallas, TX (US)

Correspondence Address: Howard Chen;Preston Gates & Ellis LLP, Suite 1700, 55 Second Street, San Francisco, CA, 94105, US

(73) Assignee: EdExpress, Inc., Plano, TX (US)

(21) Appl. No.: 11/088,196

(22) Filed: Mar. 23, 2005

Related U.S. Application Data
(60) Provisional application No. 60/555,746, filed on Mar. 23, 2004.

(51) Int. Cl. G09B 5/00

(52) U.S. Cl. 434/307 R

(57) ABSTRACT

A data processing system is disclosed for helping user(s) purchase an educational service or product. A profile module is used for managing at least one personal profile managed by the user. An education module locates at least one education provider providing the educational service or product of the user's interest based on the personal profile. A financing module locates at least one financial source available to the user based on the personal profile for financing a purchase of the educational service or product. A financial planning module compares a cost of the educational service or product and one or more available resources from the financial source for indicating a financial preparedness of the user for purchasing the educational service or product, wherein the financial planning module, the education module, and the financing module interact with the user through one or more user interfaces provided by the data processing system.

### CROSS REFERENCE

The present application claims the benefits of U.S. Provisional Patent Application Ser. No. 60/555,746, which was filed on Mar. 23, 2004 and entitled “DATA PROCESSING SYSTEM FOR EDUCATION FINANCING.”

### BACKGROUND

The present invention relates generally to a data processing system, and more particularly to a data processing system configured for financing a purchase of educational services or products.

In the present economy, the workforce is becoming more and more highly educated. As the workforce becomes even more internationally integrated, workers rely on obtaining better education to stay competitive in the job market. Therefore, education has become more and more valuable.

However, education does not come without costs. As education becomes more and more valuable, cost of education will only rise to levels not manageable by traditional means of financial management. For example, it is typical for a university to charge as much as twenty-five thousand US dollars in annual tuition, and as much as fifty thousand US dollars for professional degrees such as law and medication. In fact, it has been well-documented that educational cost has increased at a faster rate than the rate of inflation, the economy's barometer of changes in general price level. Because of the high cost in education, many families start early in their financial planning of their future cash flows in the context of education. Some families start planning education financing for their children as early as few days after they are married. This issue concerns not only middle-income families but all families who struggle to make ends meet. This issue also concerns families who desire to provide the highest quality of education that they can afford to their children. Undoubtedly, these children are the economic pillars of the future, and today's efforts must be maximized to ensure that they can obtain the highest quality of education they may afford.

At the same time, advancement in technologies has enabled financial transactions to be performed on the Internet. In an example, many families now use online banking services, including bill payments and money transfers. In another example, many families also pay their credit card bills and taxes over the Internet. In yet another example, many families manage, transfer and organize their credit card reward and rebate points over the Internet. It is thus inevitable that advancement in technologies have enabled families to perform various financial planning functions over the Internet.

Also at the same time, advancement in technologies has enabled families to perform education research over the Internet. In one example, many families research universities and colleges by visiting their websites over the Internet, instead of writing a letter requesting for printed brochures, as was common just a decade ago. In another example, many families compare universities and colleges by looking up college ranking pages over the Internet, and sorting the listed colleges based on a variety of factors predefined by the publisher of those college rankings. However, many of these functions are provided by a number of separate websites and do not consider a variety of other factors that are important to a particular family or a child.

As such, desirable in the art of data processing system is a data processing system that can link together a plurality of functions related to educational consumption, thereby allowing a user to financially plan for a purchase of educational services or products.

### SUMMARY

The invention discloses a data processing system for helping a user to purchase an educational service or product. In one embodiment, the data processing system includes a profile module, education module, financing module, and financial planning module. The profile module is used for managing at least one personal profile managed by the user. The education module locates at least one education provider providing the educational service or product of the user's interest based on the personal profile. The financing module locates at least one financial source available to the user based on the personal profile for financing a purchase of the educational service or product. The financial planning module compares a cost of the educational service or product and one or more available resources from the financial source for indicating a financial preparedness of the user for purchasing the educational service or product, wherein the financial planning module, the education module, and the financing module interact with the user through one or more user interfaces provided by the data processing system.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A illustrates a functional diagram which exemplifies the relationship of the physical components of a data processing system in accordance with one embodiment of the present invention.

FIG. 1B illustrates a functional diagram which exemplifies the relationship of the modular components of the data processing system in accordance with one embodiment of the present invention.

FIG. 2 illustrates the financing module in accordance with one embodiment of the present invention.

FIG. 3 illustrates the education module in accordance with one embodiment of the present invention.

FIG. 4 illustrates the financial planning module in accordance with one embodiment of the present invention.

FIG. 5 illustrates the merchant module in accordance with one embodiment of the present invention.

FIG. 6 illustrates a functional diagram which exemplifies a portal structure of the data processing system in accordance with one embodiment of the present invention.

### DESCRIPTION

The present invention provides a data processing system that can link together a plurality of functions in educational research and financial planning for education costs. Although the invention is illustrated and described herein as a method and system for providing education financing in the context of present day technologies, it is nevertheless not intended to be limited to the details shown, since various modifications and structural changes may be made therein without departing from the spirit of the invention and within the scope and range of equivalents of the claims.

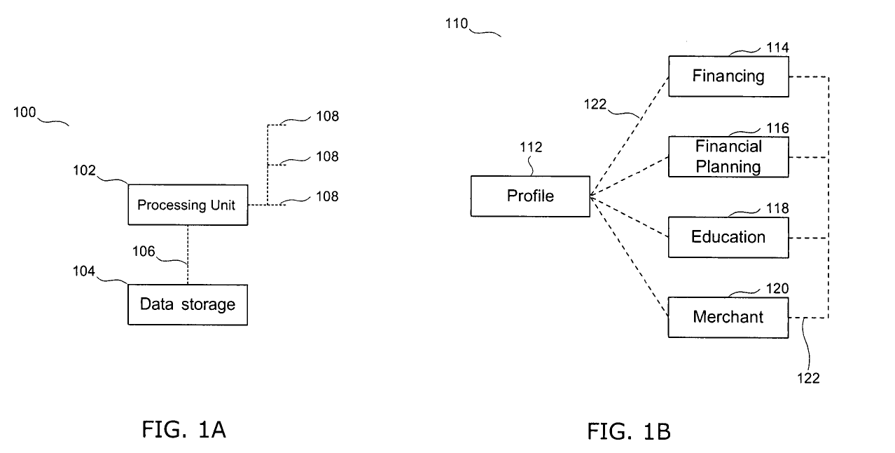

FIG. 1A presents a functional diagram 100 which exemplifies the relationship of the physical components of a data processing system in accordance with one embodiment of the present invention. The data processing system includes a processing unit 102 and a data storage 104. The processing unit 102 may be an application server that houses one or more modular components, and may process data related to a user of the data processing system. It is understood by those skilled in the art that the processing unit 102 may include a variety of operating systems and hardware components, and that the processing unit 102 may include a network of computers that collectively provide the functions and house the modular components. It is also understood that the user may be an individual who is a member of the data processing system, or an individual who may not be a member but merely a visitor interested in the data processing system. It is also understood that a new user refers to an individual who has recently signed up, while a current user refers to an individual who has signed up and has an account in the data processing system. Furthermore, the user may be a student intended to consume education, as well as any family member or friends who may be interested in contributing towards the student's cost of education.

While it is generally understood that the data processing system may limit the number of household or related members affiliated with a main member (for example, up to five household members per main member), the data processing system may relax such limits from time to time to accommodate varying needs. While it is generally understood that other family members and friends may contribute towards the student's cost of education, they may also utilize the data processing system to perform other functions, such as shopping and education research, that may or may not directly be related to the student's education financing. While it is generally understood that only the student and authorized family members (e.g. parents) may have access to financial planning tools of the student, the data processing system may allow the student and authorized family members to authorize other individuals (e.g. family financial planner) to have access to one or more financial planning tools. Furthermore, it is also understood that the term “user” may refer to any of the above definitions, and may be used interchangeably in different examples without deviating from the spirit of this invention.

The data storage 104 may be a hard disk linked to the processing unit 102, or a storage area network (SAN) module that houses one or more databases storing data related to the user. The data storage 104 may also store one or more account numbers, as well as one or more personal profiles of the user. The processing unit 102 may be linked to the data storage 104 by a data bus 106, which may be a small computer system interface (SCSI), a fibre channel or any other communicative buses that facilitate exchange between the processing unit 102 and the data storage 104. The processing unit 102 may also connect, via a plurality of connectors 108, to a plurality of other processing units and data storages. As an example, these processing units may include merchant, service partner, member, and user processing units, while these data storages may include credit card databases, merchant databases, College Board databases and other databases that provide data to the data processing system. It is understood that a merchant and service partner may refer to companies providing goods and services, respectively, to the users of the data processing system. These companies operate in conjunction with the data processing system, and may be referred as in-network merchants or service partners. The credit cards issued by the data processing system may be referred as in-network credit cards. As understood by those skilled in the art, the connectors 108 may be Ethernet, 802.11b Wireless network, modem connections etc.

FIG. 1B presents a functional diagram 110 which exemplifies the relationship of the modular components of the data processing system in accordance with one embodiment of the present invention. The modular components include a profile module 112, a financing module 114, a financial planning module 116, an education module 118 and a merchant module 120. The modules 112-120 are modular components that are operable by the processing unit 102 connected with the data storage 104. The modules 112-120 are functionally linked, via connectors 122, to ensure that data in one module may be accessed by and written to another module.

The profile module 112 may include a variety of data that are populated by a user. For example, the user points to the website front-end of the data processing system and clicks to the registration page, whereupon the user enters data related to the user or other people whose personal profiles are managed by the user. For example, such other people can be the family members of the user. It is understood that the user interacts with the modules 112-120 through a single website front-end, a custom application, or any other means through which the data and functions in the modules 112-120 may be adequately presented to the user.

To illustrate what kind of data may be included in the profile module 112, three examples will be provided. In the first example, the profile module 112 may include biographical data related to the user, including name, date of birth, social security number, citizenship, gender and residency. In the second example, the profile module 112 may include performance data related to the user, including class rank, grade point average, athletic ability etc. In the third example, the profile module 112 may include a plurality of account numbers, account balances, education point balances as well as other data that are used by the data processing system. The profile module 112 may also provide other functions, such as the ability to automatically generate profile data based on a population table, which may be provided to the data processing system by partners of the data processing system who are offering membership and usage of the data processing system as an employee benefit. The population table may also be provided by merchants and service partners of the data processing system who are offering membership and usage of the data processing system as a purchase inducement or premium. While two examples of the sources of the population table are given, it is understood by those skilled in the art that other sources may also provide profile data to the profile module 112 without deviating from the spirit of this invention.

The profile module 112 may also provide other functions. For example, the profile module 112 may include a registration module, where a user may populate biographical and performance data related to the user. The user may also register one or more credit cards that may be associated with the user's profile.

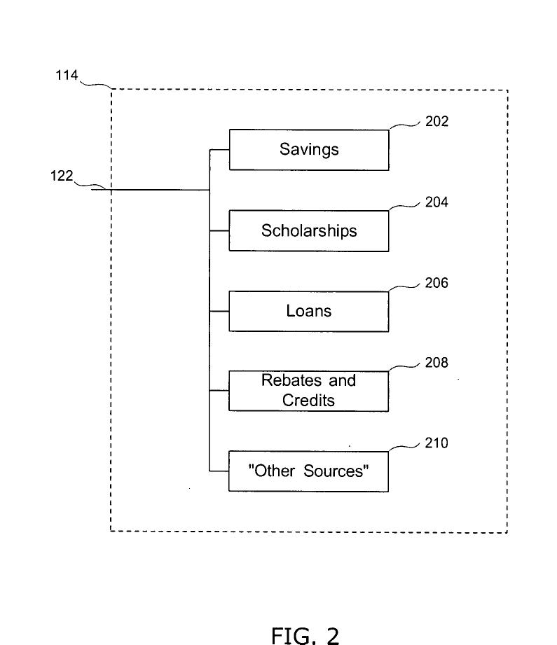

The data in the profile module 112 may be used to indicate information that is stored in other modules of the data processing system. For example, the personal profiles in the profile module 112 may allow the user to search for specific education institutions, loans and scholarships. While various examples have listed some of the data stored in the data processing system, it is nevertheless understood by those skilled in the art that other data may also be stored in the data processing system without deviating from the spirit of this invention. The modules 114-120 will be discussed in FIGS. 2-5.

FIG. 2 illustrates the financing module 114 in accordance with one embodiment of the present invention. The financing module 114 includes a savings module 202, a scholarships module 204, a loans module 206, a rebates and credits module 208 and an “others sources” module 210. The financing module 114 also connects, through the connector 122, to the rest modules of the data processing system.

The chief function of the financing module 114 is to provide a system and method for a user to search for, locate and manage financial sources for education funding. As an example, one such financial source may be a savings account or a brokerage account, which may be managed by the savings module 202. The user may allocate a certain amount of money from the user's savings account and/or brokerage account towards education financing, after which the savings module 202 may add that amount of money to the financial source located by the financing module 114. A estimate funding of the financial source may then be submitted to the financial planning module 116 for education financial planning.

As another example, another financial source may be public and private scholarships, which may be managed by the scholarships module 204. Specifically, these financial sources may include athletic scholarships, religious scholarships, corporate scholarships and minority scholarships, as well as scientific fellowships. The scholarships module 204 may provide a search engine that allows the user to search for scholarships that match the user's personal profile. For example, if the user is a minority female, the search engine of the scholarships module 204 may return such scholarships as “Alice Paul Scholarship” and “Minority in Higher Education Scholarship” etc. The user may also search for scholarships by entering specific criteria to the search engine. For example, if the user searches for “science”, the search engine of the scholarships module 204 may return such scholarships as “James D. Watson Scholarship” and “Marie Curie Memorial Scholarship” etc. The search engine of the scholarships module 204 may also relax some rules to ensure that an adequate list of scholarships is returned to the user. For example, if the user searches for “chemistry for females”, the search engine may not only return exact matches, such as “Marie Curie Memorial Scholarship”, but also partial matches, such as “Alice Paul Scholarship”, which may allow the user to study for any subject the user may so choose. If the search engine returns too many entries, the user may use a plurality of filtering options to limit the search. For example, a search for “science” may result in hundreds of hits. The scholarships module 204 may then prompt the user to limit the search by intelligently requesting the user to limit the search based on one or more of the user's personal profile data, including gender and subject. The scholarships module 204 also has the function of providing the user with a check list of the items needed for submitting with an application for a particular scholarship. For example, the check list may include an essay written by the scholarship applicant, a check and a tax return document. The scholarships module 204 allows the user to submit or upload the needed items together with the application. Before submitting the application, the scholarships module 204 will check the application for completeness and notify the user of any missing items.

The scholarships module 204 may also provide various functions other than a search engine for scholarships. For example, the scholarships module 204 may from time to time send the user, via electronic mail or any other predefined communication means, a list of scholarships that are most recently made available by their sources. For example, a user may perform a search on a Monday, but on Wednesday of the same week a new scholarship may be available that the user may be interested in applying. The scholarships module 204 may then send that information to the user to ensure that the user is informed of the newly-available scholarship. The scholarships module 204 may also provide a form-fill function, by which all or part of a scholarship application form may be filled out by using data available in the user's personal profile. If the user receives and accepts one or more scholarships, the scholarships module 204 may increment the aggregate amount provided by the financing module 114. Such aggregate amount may then be submitted to the financial planning module 116 for education financial planning.

It is understood by those skilled in the art that the scholarships module 204 may manage other types of financing sources, including federal grants, general opportunity grants, Pell grants, state grants etc. These financial sources are managed by the scholarships module 204 in similar fashion to the management of the financial sources of the scholarships. The scholarships module 204 may also retrieve up-to-date data from all levels of government, including FAFSA data, state grant data and other financial source data. The scholarships module 204 also has the function of notifying the user of particular events and deadlines that he should be aware of when applying for a scholarship. For example, such events and deadlines include cutoff dates for applications and an FAFSA calendar for submission of documents.

As yet another example, another such financial source may be public and private loans, which may be managed by the loans module 206. It is noted that the scholarships module 204 is summarily different from the loans module 206 in that the former chiefly deals with financial sources that do not involve any non-trivial end-of-period cash outflow, while the latter deals with financial sources that may have non-trivial end-of-period cash outflow as a result of principal repayment, as well as period cash outflow as a result of interest payment. Specifically, these financial sources may include public and private loans. Public loans include federal Stafford loans, federal plus loans, Sallie Mae loans etc., while private loans include bank student loans and other government-approved private student loans. The loans module 206 may provide a search engine that allows the user to search for loans that match the user's personal profile. The loans module 206 may also provide other functions in loans management, including electronic mail notification of newly-available loans, automatic population of loans application data etc. For example, if a user searches for “$10,000 at 2.5% APR repayable in T+4 with annual $1,000 travel and entertainment line of credit”, the search engine of the loans module 206 may return an offer from a commercial bank that provides a $10,000 loan with an annual interest rate of 2.5% and a full repayment of principal four years after graduation, as well as a $1,000 annual line of credit for travel and entertainment expenses. Other functionalities are similar to what is described for the scholarships module 204. When the user accepts a loan offer, the loans module 206 may increment the loans amount to the aggregate amount of the financing module 114. Such loans may then be submitted to the financial planning module 116 for education financial planning. It is noted that, similar to the scholarships module 204, the loans module 206 has the function of providing the user with a check list of the items needed to be submitted with the applications and checking the applications for completeness. Also, the loans module 206 allows the user to submit or upload the needed documents or information that is not provided in the personal files together with the applications.

As yet another example, another such financial source may be rebates and credits from purchases of consumer goods and services, which may be managed by the rebates and credits module 208. Specifically, these financial sources may include cash and credit rebates accumulated while the user purchases consumer goods and services at brick-and-mortar companies as well as online stores.

This type of financial source is summarily different from the financial sources affiliated with the savings module 202, the scholarships module 204 and the loans module 206 because the cash inflow may begin as soon as the user purchases goods and services, not when the user actually consumes education. One prior art has provided that such financial sources may be directed into a fiduciary trust that collects transient monies inflow and distributes monies only when the user actually consumes education. (See U.S. Pat. No. 6,484,147 granted to Brizendine et al. for more details.) For example, the rebates and credits module 208 may allow users to accumulate rebates, credit card cash back, rebates on credit card purchases as well as rebates from service partners in the trust fund. The rebates and credits module 208 may increment any such rebates and credits to the aggregate amount of the financing module 114. Such accumulation will be paid against any future education cost. A tiered rebate mechanism may allow users to earn higher levels of rebate based on individual or aggregate purchases of consumer goods and services. For example, a 5-tiered program may include the following customer classifications: sporadic (less than $251 of annual spending), average ($251 to $750), average-to-loyal ($751 to $1,500), dedicated ($1,501 to $3,000) and ideal (more than $3,000). The rebate percentages to the classifications are: 1%, 2%, 3%, 4% and 5%, respectively. In this 5-tiered program, if a user spends $1,000, the user is a tier-3 customer, who receives $2.50 (1% of $250) for the first $250 in expenditure, $10 (2% of $750−$250) for the next $500 in expenditure, and $7.50 (3% of $1,000−$750) on the remaining $250 in expenditure. In this case, the weighted rebate percentage is 2.00% ([$2.50+$10+$7.50]/$1,000). If the user were to double spending to $2,000 and become a tier-4 customer, the weighted rebate percentage becomes 2.75%: the user receives $2.50 (1% of $250) for the first $250 in expenditure, $10 (2% of $750−$250) for the next $500 in expenditure, $22.50 (3% of $1,500−$750) for the next $750 in expenditure, and $20 (4% of $2,000−$1,500) on the remaining $500 in expenditure, thereby giving a weighted rebate percentage of 2.75% ([$2.50+$10+$22.50+$20]/$2,000). In other words, the data processing system encourages users to increase spending by increasing the weighted rebate percentage based on spending levels.

The rebates and credits module 208 is provided with a calculator for predicting rebates for transactions contemplated with individual service partners or synergistic groups of service partners. For example, a user contemplating a real estate transaction may use one or more of the following examples of service partners; a real estate broker, a mortgage company, a title company, a moving company, a home security company and others. The available rebates vary by the type of services considered (a real estate broker may provide an increased rebate if the user decides to both buy and sell property using that broker) and the combination of service providers used (a moving company may provide a higher rebate if their preferred service partner for home security services is used.) The calculator accepts the various services, provides combinations and options, and predicts the potential rebates that will be returned to the user.

The rebates and credits module 208 has a group purchase function, which allows a group of people to make a purchase from the merchants or service partners through the data processing system. The group of people may include one or more users and other people related to the users, such as their friends and family members. Each individual of the group of people contributes a percentage of money used to purchase a product or service from the merchant or service partner, respectively. The merchant or service partner returns a rebate to the group of people based on the purchase price. The rebate is then divided according to the contribution percentage of each individual among the group of people.

As yet another example, another such financial source may be “other sources” not previously mentioned. Such sources may include internship and co-op opportunities, and may be managed by the “other sources” module 210. For example, the “other sources” module 210 may provide a search engine for users to search for such other sources. The search engine may also prompt the user to answer a plurality of questions, such as “Are you familiar with computers?”, or “Have you filed books in a library before?” If the answers to both are “Yes”, the search engine may return such results as “Computer technician at BestBuy” and “Books filing assistant at the Dallas Public Library”, respectively. The pay scales for these internships and co-ops may be obtained, through their respective employers, by the “other sources” module 210, and, based on the user's preference of how many hours of work the user is willing to perform in any given week or in any given term break. Any income derived from internship and co-op will be incremented by the “other sources” module 210 to the financing module 114. Such “other sources” may then be submitted to the financial planning module 116 for education financial planning.

In other words, the user may fund the cost of education by a plurality of financial sources, searchable through a plurality of modules in the financing module 114. The user also may, through the financing module 114, decrease and increase allocation mix of all financial sources. For example, if the user decides that fewer loans and more scholarships will be used, the user may change parameters in the financing module 114 such that more scholarships will be searched and applied, while any accepted loan terms may be renegotiated to suit the user's preferences. The user may obtain unplanned financial sources while consuming education, such as a departmental prize, and may afford to reduce funding amounts from other sources such as internship or loans. Such transactions will be enabled by the financial planning module 116, which will be illustrated and discussed in detail below.

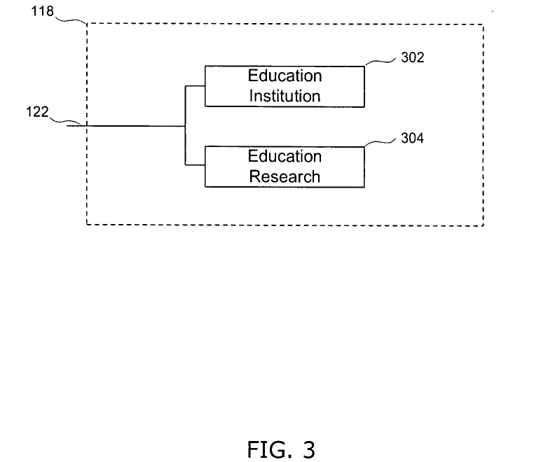

FIG. 3 illustrates the education module 118 in accordance with one embodiment of the present invention. The education module 118 includes an education institution module 302 and an education research module 304. The education module 118 is connected, via the connector 122, to the rest of the data processing system. The education institution module 302 provides a search engine which allows the user to search for a particular education institution based on the user's personal profile, predefined preferences, or institutional attributes. Institutional attributes may include geographical location, accreditation, tuition, fees, costs, degrees conferred, courses offered etc. For the purpose of illustration, institution hereinafter refers to colleges and universities, although it is understood by those skilled in the art that the data processing system may cater to the education financing requirements of K-12 or professional education, and that institution may also refer to K-12 public schools, K-12 private schools, K-12 parochial schools, trade schools and other education institutions served by the data processing system. Other institutions, such as distance learning institutes, continuing education programs as well as online programs may also be served by the data processing system, even though they are not illustrated as examples, without deviating from the spirit of this invention.

To illustrate how the education institution module 302 operates, a user from Dallas, Tex. may be interested in a college close to home. After searching for “an institution close to home”, the search engine may return “University of Texas, Dallas”, “Southern Methodist University” etc. If the list returned is too long, the search engine may prompt the user to provide additional limiting criteria, e.g. “university with a law faculty.” The search engine may then return “Southern Methodist University.” The user may select more than one college choice, thereby allowing the user to compare and contrast the education opportunities offered by a variety of institutions. In an example, the education institution module 302 may allow the user to rank such quantitative characteristics as the student-faculty ratio of various institutions. In another example, the education institution module 302 may allow the user to rank such qualitative characteristics as student satisfaction of various institutions. In yet another example, the education institution module 302 may provide the user a list of “feeder schools”, given the user's past and present institution affiliation(s). Such a list of “feeder schools” may be valuable for users who may otherwise not be familiar with historical trends and statistics pertaining to the relationship between an institution of interest, and past and present institution affiliation(s). After a particular college is selected, the education institution module 302 may send the estimate cost of education to the financial planning module 116.

The education institution module 302 may also provide other functions to the user, such as the ability to download or submit an application from or to an education institution. The education institution module 302 may then populate the application based on data available in the user's profile located in the profile module 112.

The education research module 304 may include a tutor database that allows a user to find a nearby tutor for a specific subject. As an example, after the user searches for “Grade 11 biology tutors”, the education research module 304 may return a list of high-school biology tutors available in the user's residency area. As another example, after the user searches for “What is Boyle's Law?”, the education research module 304 may return a list of physics tutors available in the user's residency area. The education research module 304 may also submit a change in education financing cash flow to the financial planning module 116, i.e. the estimate cost of tutoring may directly be credited against any asset account available in the financing module 114.

The education research module 304 may also provide other research materials users who are scheduled to consume education. For example, web links may point to reference materials such as dictionaries, thesaurus, encyclopedias as well as research libraries, tutorials, educational games, homework chat rooms and education-related web-logs—any combination of which may be utilized by the user to research on a homework problem, to satisfy an educational curiosity, or to engage in activities related to education. These links may further be categorized into “free” links, “partner” links, as well as “pay-as-you-go” links. If such links require subscription, any such subscription cost may be directly credited by the education research module 304 against any asset account available in the financing module 114.

The education research module 304 may also provide research materials to users who are not scheduled to consume education. For example, parents of a user, who consumes or is scheduled to consume education, may search for academic-based day care, after-school programs, academic camps, summer school opportunities as well as international exchange opportunities. Such research materials provided to users who are not scheduled to consume education may be necessary because some users who are scheduled to consume education may be a minor not legally able to apply for opportunities detailed in the research materials.

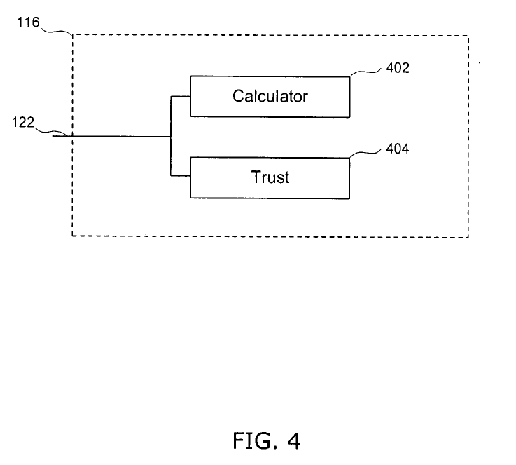

FIG. 4 illustrates the financial planning module 116 in accordance with one embodiment of the present invention. The financial planning module 116 includes a calculator module 402 and a trust module 404. The financial planning module 116 connects, via the connector 122, to the rest of the data processing system.

The financial planning module 116 may perform a variety of functions. For example, the financial planning module 116 may provide financial analysis tools for side-by-side scenario comparisons: a user, who may have various contrasting cash flow structures based on the choice of loans types, may be able to compare and contrast the cash flow structure of different scenarios side-by-side. The financial planning module 116 may also provide sensitivity analysis, whereby the cash flow structures may be altered based on fluctuations in related factors such as interest rates and personal credit history.

The calculator module 402 may include complex mathematical models, analytical systems, costs matrices as well as other economic data (such as interest rate, Sallie Mae variable base rate etc.) that are relevant in computing future cash flows. The calculator module 402 also provides the user the ability to negotiate the financial planning outcome by decreasing and increasing the allocation mix of all financial sources. In other words, the calculator module 402 retrieves all educational institution costs and financing sources, and may compare and contrast a plurality of balances thereof for various educational institutions.

The trust module 404 includes mechanism that allows rebates and credits to be placed in a third-party education trust, and to be paid out in cash or in kind as the user consumes education. The trust module 404 may also include other management tools for the users to manage rebates and credits. The trust module 404 includes a mechanism to allow users to transfer money from one account into another. This allows family members or friends to increase the funds available for education purposes of another user.

By tying college choice, which is managed by the education module 118, to financing, which is managed by the financing module 116, financial planning may be realized. In financial terms, by tying the cost of education to the financing source of education, cash flow management of education financing through the data processing system may be realized.

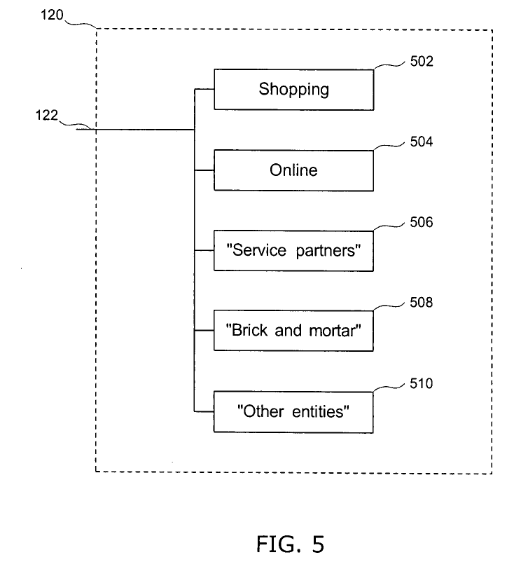

FIG. 5 illustrates the merchant module 120 in accordance with one embodiment of the present invention. The merchant module 120 includes a shopping module 502, an online module 504, a “service partners” module 506, a “brick and mortar” module 508 and an “other entities” module 510. The merchant module 120 is connected, via the connector 122, to the rest of the data processing system. The chief function of the merchant module 120 is to allow the user to collect any rebates and credits from the purchases of consumer goods and services to the user's profile in the data processing system, and to allow such rebates and credits to be posted to the trust module 404 of the financial planning module 116.

In an “online merchant” example, a user may purchase $200 worth of textbooks from Amazon.com. If any user of the data processing system earns $1 of trust money for every $100 spent online, the user in this case will earn $2 (i.e. $200/100), which may be posted by the online module 504 to the trust module 404. In other words, the $200 purchase results in a two-dollar increase in the trust account of the user in the trust module 404.

The term “service partners” is referred to certain service providers who provide non-retail type of service. Wells Fargo Home Mortgage, Prudential Relocation Services, Brinks Home Security, Telephone companies and Electricity companies are examples of such service providers. They provide a percentage of the price of the service as the rebate. For example, Wells Fargo Home Mortgage provides rebates at a 0.25% rate of the face value of the mortgages.

In a “brick and mortar” example, BestBuy is a “brick and mortar” partner of the data processing system, and “brick and mortar” agreement between BestBuy and the data processing system, as an example, specifies that five percent of computer-related purchase amount (but none for console games purchase) will be refunded to the trust module 404. When a user purchases $500 worth of computer equipment and $100 worth of console games from BestBuy, $6 (i.e. [$500+$100]/100) is posted by the “brick and mortar” module 508 into the trust account of the user in the trust module 404 for dollar purchases, while $25 (i.e. 5% of $500 computer purchase amount) is posted by the “brick and mortar” module 508 into the trust account of the user in the trust module 404 for the performance of “brick and mortar” agreement terms.

Other shopping rebates and credits may be posted by the “other entities” module 510 to the account of the user in the trust module 404 according to the mechanics of the “other entities” module 510. Such rebates may, as examples, include credits from cable companies for subscribing to plans that include education channels such as History and Discovery channels, or credits from certain apparel and boot companies if the user is applying to a uniformed military academy. It is understood by those skilled in the art that the credits posted by the “other entities” module 510 to the trust module 404 may be used to finance cost of education, as illustrated earlier.

The shopping module 502 provides a plurality of functions to the user. For example, the shopping module 502 may, from time to time, send proactive product rebate notifications (e.g. notifications in the form of electronic mail) for shopping opportunities, based on a variety of factors, including those that may be specified in the user's profile. The shopping module 502 may also deploy a plurality of smart agents who may synthesize purchase behavior based on a change in a user's lifestyle. For example, smart agents, upon recognizing that a user may be interested in buying a house, may notify the user that other services such as real estate agency, mortgage financing, moving, title transfer etc. may also be within the merchant network of the data processing system, thereby increasing the possibility of a win-win situation for merchants (by cross-selling) and for the user (by maximizing in-network rebate and credit points). In another example, smart agents may cross-sell legal services, small business loans, real estate agency etc. to a user who may be interested in starting up a small business. In yet another example, smart agents may perform other notification functions, such as capturing changes in the income level of the user and notifying the said user to ensure that education will be adequately funded despite those changes.

The merchant module 120 may aggregate user purchase history, activity and trends from the online module 504, the “service partners” module 506, the “brick and mortar” module 508 and the “other entities” module 510. The merchant module 120 may provide partners (i.e. online companies, service partners, “brick and mortar” affiliates, and other related entities) with a partner portal. The partner portal may provide a set of reports reflecting the purchase history, activity and trends related to that partner. For example, the data processing system may provide a partner portal to Wells Fargo, who may be a service partner and a private loans source. The partner portal for Wells Fargo may include the number of website hits Wells Fargo may get for any defined period of time (i.e. week, month, year, year-to-date). The partner portal may also include the number of loans applications Wells Fargo may get, or the aggregate value of rebates Wells Fargo may have paid out, for any defined period of time.

The merchant module 120 may also provide a variety of calculation systems for merchants. One such calculation system may be a margin impact calculator, which may be used by merchants to simulate net results by varying key variables. Key variables include: general business margins, user spending levels, margin impact on various types of sales (e.g. incremental sales, credit card sales, cash sales, financed sales), incentives provided to the data processing system (based on whether or not the data processing system is able to attract and retain the most loyal or “high value” users), mix of current and new spending at the merchant, percentage of users using an in-network credit card etc. It is understood that new users and incremental sales generally have a higher margin impact, while current users and financed sales generally have a lower margin impact. It is also understood that the margin impact to a merchant is total impact, based on the aforesaid factors, minus the amount of in-network rebate provided to users as well as incentives provided to the data processing system for attracting and retaining “high value” users. By varying one or more of the aforesaid variables in the margin impact calculator of the merchant module 120, the merchant may be able simulate pro forma results and budgetary projections.

Another such calculation system may be a merchant impact calculator, which may be used by merchants to generate margin impact based on assumptions such as revenues, costs, current margins (revenues minus costs), rebate schedules and customer mix. The merchant first stipulates a predictable level of incremental revenue for a customer mix (e.g. a mix including new users who are signed up by the merchant, new users who are signed up by the data processing system, current users, and non users). For example, the predictable level of incremental revenue for the four customers may respectively be $5, $2.75, $0 and $0. The merchant impact calculator then adds the predictable level of incremental revenue to the current margin, and then subtracts the rebate schedules from the sum to derive the new margin, the new margin in percentage, the net increase in margin, and the percentage increase in margin. If the wholesale cost is $1.50, the current margin is $1 and the rebate amount is $0.50, the new margin will be $5.50 ($1+$5−$0.50) for a new user who is signed up by the merchant. The new margin in percentage will be 220% ($5.50/[$1.50+$1]). The net increase in margin will be $4.50 ($5.50−$1), and the percentage increase in margin will be 180% ($4.50/[$1.50+$1]). The merchant impact calculator may also derive the margin impact based on the above calculations. If 10% of the customer mix are new users who are signed up by the merchant, these new users' current margin contribution to the customer mix per $1,000 in sales will be $40 ($1,000*10%*[220%−180%]). These new users' new margin contribution to the customer mix per $1,000 in sales will be $220 ($1,000*10%*220%), thereby giving an increase of $180 of margin amount or an increase of 180% in percentage terms. It is noted that the merchant may also provide rebates on a group purchase basis as discussed above.

By providing a data processing system whereby a user may align financing sources with the cost of education, whereby a user may research institutions and education-related information and whereby a user may manage rebates and credits posted to an education trust, the user may ensure adequate cash flows may be directed to the highest quality of education one may afford.

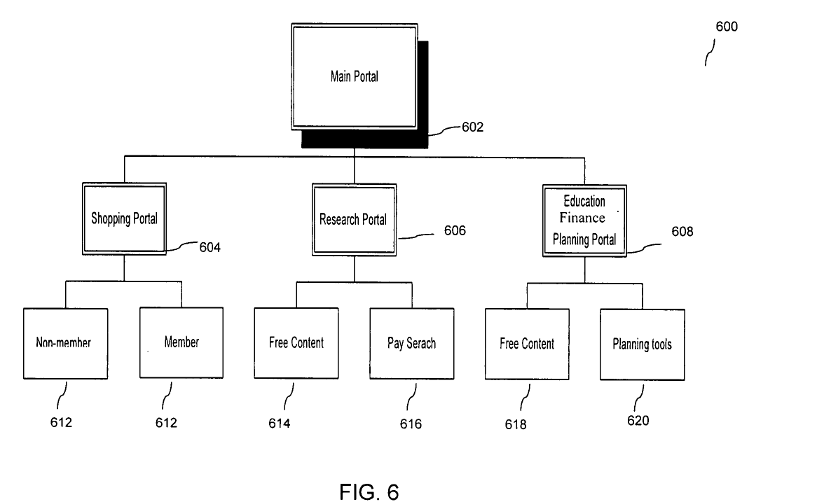

FIG. 6 illustrates a functional diagram 600, which exemplifies a portal structure of the data processing system in accordance with one embodiment of the present invention. The website includes a main portal 602 serving as the main point of entry. The main portal 602 is divided into a shopping portal 604, research portal 606 and education finance planning portal 608, which serve as sub-entry points to various education related categories accessible through the data processing system.

The shopping portal 604 serves as an entry point for shopping products and services, such as books, gifts, electronic devices, computers, travel services, etc. The shopping portal 604 is further divided into a non-member shopping category 610 and a member shopping category 612. A non-member may be asked to join the membership in order to shop via the shopping portal 604. A member 612 may shop via the shopping portal 604, and earn a percentage of her spending as a rebate. As discussed above, the rebate will be placed in a trust fund until the member redeems it for financing a purchase of educational services or products.

The research portal 606 serves as a main entry point for educational information research. The research portal 606 is divided into a value-added research category 614 and a premium research category 616. The value-added research category 614 of the research portal 606 provides a gateway to a variety of educational contents, which include course-specific materials, interactive software, and hyperlinks to other online educational information providers. For example, the value-added category 614 of the research portal 606 creates an integral interface between the data processing system and HowStuffWorks.com. With over six millions of visitors each month, HowStuffWorks.com is widely recognized as a leading source for clear, reliable information that explains how everything around us works. It is noted that a member will not be charged in addition to the initial membership fee for conducting a value-added research.

The premium research category 616 allows a user to search certain specialized materials, such as academic journals, upon paying a fee. A search engine is used for helping the user to comb through thousands of academic journals and millions of book bibliographic entries to get the predetermined information. One example of such search engine may be the one used by Learner's Library. The Learner's Library is a website that provides a cost effective consumer access to full text, copyright cleared academic articles and library oriented bibliographic data with copy, paste, print and save capabilities while at the same time exporting proper citation checking of written works.

The education finance planning portal 608 serves as a main entry point for searching financial resources and provides tools for financial planning. The education finance planning portal 608 is divided into a content category 618 and a planning tools category 620. The content category 618 allows the user to search for financial resources and educational institutions. The planning tools category 620 allows the user to allocate her financial resources to finance the education.

The shopping portal 604, research portal 606 and education finance planning portal 608 provide comprehensive functions and tools that satisfy various educational needs of a user. For example, the data processing system allows the user to earn rebates or credits without any additional cost to her regular shopping expenses. These rebates and credits, together with other financial sources, help the user to finance her education. The data processing system makes it easy for the user to access educational information. The data processing system also provides financial planning tools that allow the user to allocate her financial resources for financing her education. These comprehensive functions allow the data processing system to be a one-stop-shop for education-related services and products.

The above invention provides many different embodiments or examples for implementing different features of the invention. Specific examples of components and processes are described to help clarify the invention. These are, of course, merely examples and are not intended to limit the invention from that described in the claims.

Although the invention is illustrated and described herein as embodied in a design and method for, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

1. A data processing system for helping a user to purchase an educational service or product through a computer network, comprising:
a profile module for managing a personal profile of the user;
an education module for locating at least one education provider providing the educational service or product of the user's interest based on the personal profile;
a financing module for locating one or more financial sources available to the user based on the personal profile for financing a purchase of the educational service or product; and
a financial planning module for comparing a cost of the educational service or product and one or more available resources from the financial sources for indicating a financial preparedness of the user for purchasing the educational service or product,
wherein the financial planning module, the education module, and the financing module interact with the user through one or more user interfaces provided by the data processing system.

2. The data processing system of claim 1 wherein the personal profile comprises biographical data, academic performance data, and account data related to the user.

3. The data processing system of claim 1 wherein the personal profile is generated by a third party other than the user.

4. The data processing system of claim 1 wherein the financing module further comprises a savings module for allocating a predetermined amount of money in at least one financial account under a name of the user to finance the purchase of the educational service or product.

5. The data processing system of claim 4 wherein the financing module further comprises a scholarships module for locating at least one scholarship source based on the personal profile to finance the purchase of the educational service or product.

6. The data processing system of claim 1 wherein the financing module further comprises a loans module for locating at least one loan source based on the personal profile to finance the purchase of the educational service or product.

7. The data processing system of claim 1 wherein the financing module further comprises a rebates and credits module for retrieving at least one rebate from a trust fund to finance the purchase of the educational service or product, wherein the rebate is obtained by the user from at least one merchant or service partner, from whom the user has made at least one purchase.

8. The data processing system of claim 7 further comprising a merchant module for collecting the rebate provided by the merchant or service partner, from whom the user has made a purchase of goods or service.

9. The data processing system of claim 8 wherein the merchant module further comprises a shopping model for providing the user with rebate notification based on a purchase pattern of the user.

10. The data processing system of claim 8 wherein the merchant module further comprises an online module for generating the rebate based on a purchase of goods made by the user from the merchant through the Internet.

11. The data processing system of claim 8 wherein the merchant module further comprises a brick and mortar module for generating the rebate based on a purchase of goods made by the user in an off-line shop of the merchant.

12. The data processing system of claim 8 wherein the merchant module further comprises a service partner module for generating the rebate based on a purchase of service made by the user from the service partner.

13. The data processing system of claim 8 wherein the merchant module calculates the rebate based on a tiered system, wherein a higher spending on the purchase made by the user triggers a higher rate of the rebate provided by the merchant or the service partner.

14. The data processing system of claim 8 wherein the financial planning module further comprises a trust module for placing the rebate in the trust fund.

15. The data processing system of claim 14 wherein the financial planning module further comprises a calculator module for simultaneously comparing a plurality of costs of a plurality of the educational services or products with the available resources from the financial sources.

16. The data processing system of claim 1 wherein the education module further comprises an education institution module for providing a networked interface through which the user is able to download or submit an enrollment application form from or to the educational institution.

17. The data processing system of claim 16 wherein the education module further comprises an education research module for locating at least one tutor service provider or at least one educational material database.

18. A method operable by a data processing system for financing a user to purchase an educational service or product through a computer network, comprising:
generating a personal profile of the user;
locating at least one education provider providing the educational service or product of the user's interest based on the personal profile;
generating at least one rebate for the user by at least one merchant or service partner, from whom the user has made at least one purchase;
placing the rebate in a trust fund indicated by the personal profile; and
comparing a cost of the educational service or product and one or more available resources including the rebate for indicating a financial preparedness of the user for purchasing the educational service or product.

19. The method of claim 18 further comprising locating a predetermined amount of money in at least one financial account under a name of the user as one of the available resources.

20. The method of claim 18 further comprising locating at least one scholarship source based on the personal profile as one of the available resources.

21. The method of claim 18 further comprising locating at least one loan source based on the personal profile to as one of the available resources.

22. The method of claim 18 wherein the step of generating at least one rebate is based on a purchase made by the user from the merchant or the service partner through the Internet.

23. The method of claim 18 wherein the step of generating at least one rebate is based on a purchase made by the user in an off-line shop of the merchant.

24. A data processing system for helping a user to purchase an educational service or product through a computer network, comprising:
a profile module for managing a personal profile of the user;
an education module for locating at least one education provider providing the educational service or product of the user's interest based on the personal profile;
a financing module for locating one or more financial sources available to the user based on the personal profile for financing a purchase of the educational service or product, the financing module further comprising:
a savings module for allocating a predetermined amount of money in at least one financial account under a name of the user as one of the financial sources;
a scholarships module for locating at least one scholarship source based on the personal profile as one of the financial sources;
a loans module for locating at least one loan source based on the personal profile as one of the financial sources;
a rebates and credits module for retrieving at least one rebate from a trust fund as one of the financial sources, wherein the user obtains the rebate from at least one merchant or service partner, from whom the user has made at least one purchase, to finance the purchase of the educational service or product; and
a financial planning module for comparing a cost of the educational service or product and available resources from the financial sources for indicating a financial preparedness of the user in purchasing the educational service or product.

25. The data processing system of claim 24 further comprising a merchant module for collecting the rebate provided by the at least one merchant or service partner based on an online or off-line purchase made by the user.

26. The data processing system of claim 24 wherein the merchant module calculates the rebate based on a tiered system, wherein a higher spending on the purchase made by the user triggers a higher rate of the rebate provided by the merchant or the service partner.
